(19) United States
(12) Patent Application Publication
(10) Pub. No.: US 2009/0051302 A1
(43) Pub. Date: Feb. 26, 2009

(54) PROGRAMMABLE ELECTRONIC CONTROL SYSTEM, IN PARTICULAR LIGHT CONTROL SYSTEM, FOR A MOBILE HOME, IN PARTICULAR A TRAILER AND/OR MOTOR HOME AND/OR A BOAT

(75) Inventors: Udo Pech, Edelsfeld (DE); Hermann Winkler, Neunkirchen am Sand (DE); Peter Heindl, Pyrbaum-Oberhembach (DE)

Correspondence Address: Workman Nydegger;1000 Eagle Gate Tower, 60 East South Temple, Salt Lake City, UT, 84111, US

(73) Assignee: ABL SURSUM, Bayerische Elektrozubehor GmbH & Co. KG, Lauf (DE)

(21) Appl. No.: 12/185,377

(22) Filed: Aug. 4, 2008

(30) Foreign Application Priority Data
Aug. 24, 2007 (DE) 20 2007 011 932.1

(51) Int. Cl. H05B 37/02

(52) U.S. Cl. 315/362

(57) ABSTRACT

Implementations of the present invention relate to an electronic control system for a mobile home, in particular a trailer, a motor home, or a boat. The electronic control system can include at least one electrical load, a control unit which actuates the load or loads, and at least one operator control unit with one or more first operating elements, with the operator control unit being connected to the control unit in such a way that said control unit can be controlled by means of the operator control unit. A predefined overall actuation state of the control unit can be in each case associated with the first operator control element or elements. Furthermore, the control unit can be configured in such a way that it actuates all the electrical loads of the electronic control system in a respectively predefined manner in each predefined overall actuation state.

### CROSS-REFERENCE TO RELATED APPLICATIONS

The present invention claims the benefit of priority to German Patent Application No. 20 2007 011 932.1, filed Aug. 24, 2007, entitled “Programmable Electronic Control System, in Particular Light Control System, for a Mobile Home, in Particular a Trailer and/or Motor Home and/or A Boat,” the entire contents of which are incorporated by reference herein.

### BACKGROUND OF THE INVENTION

1. The Field of the Invention

The invention relates to an electronic control system, in particular an electronic light control system, for a mobile home, in particular a trailer (also called a caravan), a motor home (also called a motor caravan) or a boat.

2. Background and Relevant Art

In addition to conventional on/off switches, switches with a dimming function are commonly used to actuate lighting devices (for example lamps) in mobile homes. These switches can be used to individually switch on and switch off or dim individual lighting devices. However, particularly when there is a plurality of lighting devices in a mobile home, this leads to a large number of switches which have to be operated in each case in order to generate a desired overall lighting condition using all the lighting devices. This is particularly complicated, especially when a specific light intensity of a lighting device, which light intensity can be set by means of the dimming function, is desired in addition to merely switching on and switching off this lighting device. A further disadvantage is that overall lighting situations which have been set once often cannot be reproduced or can be reproduced again only with a great deal of effort and “trial and error” at a later time.

### BRIEF SUMMARY OF THE INVENTION

Implementations of the present invention permit an overall lighting situation to be set in a mobile home or at least in a room or area of a mobile home in a simple manner. In one implementation, this end can be achieved by an electronic control system having the features as recited in the independent and dependent claims herein.

In one implementation, for example, the inventive electronic control system for a mobile home, in particular a trailer and/or a motor home and/or a boat, comprises at least one electrical load, a control unit which actuates the load or loads, and at least one operator control unit with one or more first operating elements, with the operator control unit being connected to the control unit in such a way that said control unit can be controlled by means of the operator control unit. A predefined overall actuation state of the control unit, which state is or can be stored in the control unit and can be activated by operating the respective first operating element, is in each case associated with the first operator control element or elements. Furthermore, the control unit is designed in such a way that it actuates all the electrical loads of the electronic control system in a respectively predefined manner in each predefined overall actuation state.

The electronic control system is preferably an electronic light control system. Therefore, the load is preferably a lighting device or the loads comprise one or more lighting devices. Each overall actuation state is then accordingly an overall lighting state, that is to say the control unit controls the loads (primarily lighting devices) in a specific overall actuation state in such a way that a specific overall lighting state and therefore a specific lighting situation, also called a scene, is generated in the mobile home or at least in a room or area of the mobile home.

It goes without saying that, in addition or as an alternative to lighting devices, it is also possible to actuate other loads by means of the electronic control system. For example, a radio and/or television can be switched on or switched off in one overall actuation state; and a heating controller, an air-conditioning system and/or an alarm system can also be activated or deactivated. In addition, a blind can be opened or closed, and/or a power socket can be “activated” or “deactivated” in order to switch on or switch off any desired load which may be connected to the power socket. A variant would be, for example, the electronic control system of a plurality of ceiling lamps, a television light, a reading lamp and a blind. Depending on the wishes of the operator, presetting can or will be stored in the control unit for these loads as an overall actuation state, for example: a full lighting state, one or more partial lighting states and/or a special television lighting state. Each of these states can then be called up in a simple manner by operating the respective associated first operating element and is implemented by the control unit.

The advantages of the invention are particularly that an overall actuation state, which may be quite complex, particularly when there are a large number of loads, can be set by operating only one switch, a first operating element. In addition to merely switching on and switching off lighting devices, this may primarily include specific predefined dimming states of individual or all the lighting devices. It is therefore no longer necessary for the operator to have to set a desired overall state by operating numerous switches and possibly by time-consuming “trial and error,” but instead, simple operator control (for example by pressing a button) is sufficient to implement a desired overall state. This simple operator control results in considerable benefits in terms of convenience.

It is particularly expedient when the overall actuation state, which is in each case associated with a first operating element, is identified, in particular symbolized, by marking (in particular printing) of the corresponding first operating element. As a result, it is easier for the operator to select the desired operating element and therefore the desired overall actuation state when there is a plurality of first operating elements. In this case, it is advantageous when the symbols used for marking purposes correspond to the respectively associated state, for example: a sun for a daytime state, a moon for a nighttime state, a TV symbol for a state which is suitable for watching television, an on/off symbol for a state of “arriving home” or for a state of “leaving” the mobile home, etc.

The load should preferably be a lighting device or the loads should comprise one or more lighting devices, so that each overall actuation state is an overall lighting state. In this case, the control unit is expediently designed to switch on and switch off and/or to dim the lighting devices. Dimming functions of individual lighting devices can be controlled, for example, by means of multiple-key operator control units. However, single-key systems are particularly advantageous for operator control of the dimming function. Examples include sliding or rotary knobs. Pressure-operated switches in which the light intensity is set by means of the duration of operation are particularly expedient.

According to a preferred development of the invention, the control unit is designed in such a way that it actuates each lighting device in each overall lighting state in such a way that said lighting device lights up with a light intensity which is predefined for the overall lighting state, or is switched off.

Therefore, a further advantage of the invention with regard to lighting devices is that defined overall states can be set, stored and called up by simple operation of the corresponding first operating element from a virtually unlimited number of possible settings in accordance with the requirements of the operator. It is therefore possible to store and, in a simple manner, without a time delay to call up, as required, overall lighting states which are matched, for example, exactly to various activities in the living area. Examples of typical overall lighting states may be “full lighting” in the case of which all (or at least a plurality of) lighting devices are activated by the control unit at full light intensity, and “reading lighting” in the case of which a reading lighting device is activated at high light intensity and other lighting devices are activated only slightly or not at all.

One development provides for the operator control unit to have one or more second operating elements by means of which the control unit can be controlled for individual actuation of individual loads. These elements are therefore used to individually set (in particular switch on and switch off or to dim) specific loads, in particular specific lighting devices. The operator can adjust this setting operation by means of the respective second operating element in accordance with its presettings. In addition, provision may be made for a state which is set by means of the second operator control elements to be stored as a new or amended overall actuation state of the control unit in said control unit, and to be called up by an associated first operating element.

It is also feasible to store an actuation state, which is set by operating the respective second operating element, for the associated loads, so that this state is initially called up again when the corresponding second operating element is operated again. This state can then be amended again as desired. The light intensity of the lamp which was set last can therefore be stored, for example in each case, in lighting devices.

It is expedient when first operating elements and second operating elements are arranged in separate element blocks on the operator control unit. This prevents confusion and allows the operator simple association. It is also expedient to mark the second operator control elements with suitable symbols for the respective loads, for example a symbol for a spotlight or an uplighter or a table lighting means.

In a particularly preferred embodiment of the invention, it is provided that the predefined overall actuation states are or can be set in the control unit by programming and/or are (or can be) stored in the control unit after the programming.

It is particularly expedient when the control unit is designed in such a way that the load or loads can be individually actuated by means of the control unit, in particular by operating the corresponding second operating elements, and an overall actuation state of the control unit which is set in this way can be stored in the control unit and can be associated with one of the first operating elements, in particular by operating this first operating element, for example for a predefined, comparatively long time, for example two or three seconds. If the corresponding first operating element is then operated again at a later point in time, the control unit automatically reestablishes the corresponding, stored overall actuation state, that is to say the corresponding overall actuation state and therefore the desired scene are reactivated in the event of lighting operations.

It is also advantageous when the overall actuation state which is in each case associated with the first operating element or elements can be changed. The operator can therefore store new settings and delete or “overwrite” settings which are no longer required.

It is also expedient to associate a predefined overall actuation state with each first operating element as a factory setting. A specific selection of scenes is therefore available to the user from the start, the function of the operator control unit is clear to the user and he is encouraged to create his own settings. To this end, it should be possible to change the factory settings, but expediently to reestablish them using a reset function.

Therefore, an electronic control system is provided overall, in which the operator can set an entire scene, in particular a lighting scene, in a mobile home by simple operation of a single operating element. To this end, various scenes can be stored in a control unit as overall actuation states. In addition, programming of the states is achieved in a simple manner, to this end the individual loads first have to be set only in the conventional manner and the set overall state is then stored, for example by prolonged pressing of an associated operating element. Setting is therefore possible without additional, special elements and/or menu navigation means. In addition, the operator does not require any special abilities for control purposes. A further advantage is that conventional switches and components which are customary in households and mobile homes, for example standard buttons, can be used for the operating elements and/or the operator control unit.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The invention and further features and advantages are explained in greater detail below using the description of exemplary embodiments and with reference to the appended schematic drawings, in which:

FIG. 1 shows a schematic illustration of the central components of an exemplary embodiment of a control system according to the invention, and

FIG. 2 shows an operator control unit of an exemplary embodiment of a control system according to the invention with first and second operating elements.

Components and parts that correspond to one another are designated by the same reference numerals in the Figures.

### DETAILED DESCRIPTION OF THE PREFERRED EMBODIMENTS

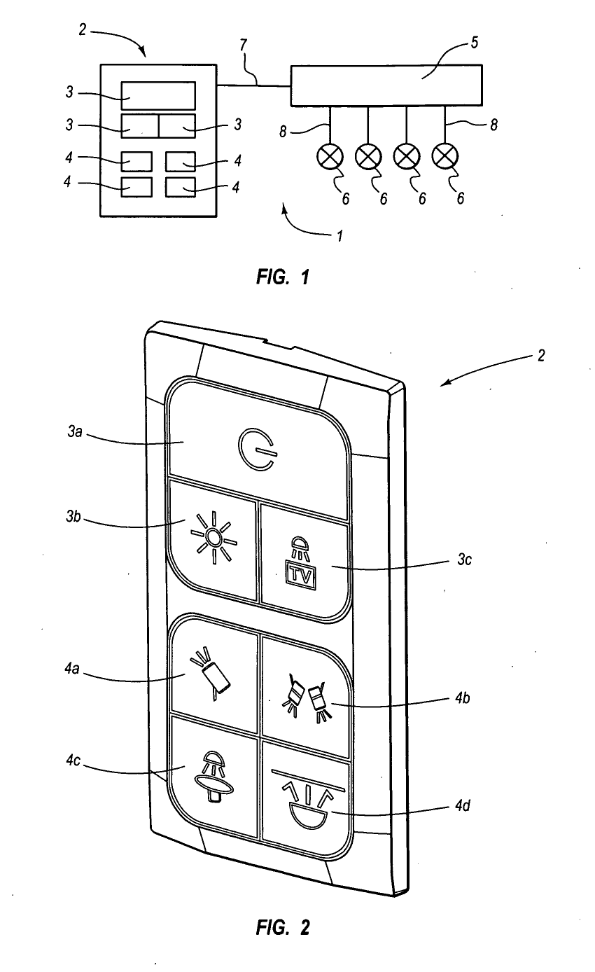

FIG. 1 shows a schematic illustration of an electronic control system 1 according to the invention comprising an operator control unit 2, a control unit 5 and a plurality of loads 6. The loads 6 are, in particular, lighting devices. The operator control unit 2 is—as schematically illustrated by the line 7—electrically connected to the control unit 5, usually via numerous electrical lines. The loads 6 are also in each case electrically connected to the control unit 5, symbolized by the line 8.

The operator control unit 2 has a plurality of first operating elements 3 for activating preset overall actuation states of the control unit 5, and a plurality of second operating elements 4 for individually actuating individual loads 6.

FIG. 2 shows an operator control unit 2 of an exemplary embodiment of any electronic control system 1 according to the invention. Said operator control unit may be, for example, the operator control unit 2 which is illustrated in the electronic control system 1 in FIG. 1. The operator control unit 2 has, in its upper region, three first operating elements 3a, 3b, 3c for activating in each case associated overall actuation states of the control unit 5. The uppermost operating element 3a is identified by a switch-on symbol and is therefore a switch-on element. By operating this switch-on element 3a, the lighting system of a mobile home, in which the electronic control system is installed (not illustrated), is switched on in a basic position. This basic position can, like further overall actuation states which are associated with the further first operating elements 3b, 3c, be set and stored. If the switch-on element 3a is operated in the switched-on state, it functions as a switch-off element, that is to say all the connected loads 6 are switched off. In the illustrated exemplary embodiment, full lighting is symbolically illustrated on the operating element 3b and television lighting 3c is symbolically illustrated on the operating element 3c as further overall actuation states.

Four second operating elements 4a, 4b, 4c, 4d for individually controlling the individual loads, in particular lighting devices, are arranged in the lower region of the operator control unit 2. These operating elements can be used to set the individual loads 6 individually, that is to say independently of the other loads 6. The respectively illustrated symbols show the loads 6 which are associated with the respective operating element 4a, 4b, 4c, 4d: operating element 4a has a single spotlight as a standing lamp, operating element 4b has double spotlight as a ceiling lamp, operating element 4c has a table lighting means, and operating element 4d has an uplighter.

The individual lighting devices 6 are connected or disconnected, preferably in a predefined or in a last-set state, by brief operation of the second operating elements 4a, 4b, 4c, 4d. As a result of longer operation of the second operating elements 4a, 4b, 4c, 4d, for example for a few seconds, the dimming function is activated and the associated lighting device becomes alternately brighter and darker over time, until the operating element 4a, 4b, 4c, 4d is released again (preferably when the desired light intensity or brightness is reached). If all the lighting devices 6 and possibly further loads are set in this way, the overall actuation state of the control unit 5—which is now preset—can be stored by relatively long operation of the desired first operating element 3a, 3b, 3c, for example for several seconds. When this first operating element 3a, 3b, 3c is later briefly operated, this overall actuation state—which is now preset—can be called up again by a single operation.

All the operating elements 3, 3a-c, 4, 4a-d may be conventional buttons which are integrated in a standard operator control unit 2. As a result, the electronic light control system can be realized in a simple and cost-effective manner.

It goes without saying that the operator control unit 2 can be arranged anywhere in the mobile home, and also physically separate from the control unit 5. It is also possible to distribute a plurality of operator control units 2 in the home, for example in various rooms. These operator control units may be at least partially identical in terms of the operating element assignment to overall actuation states. In this case, specific scenes can be called up from a plurality of operator control units.

Provision is therefore made, overall, of an electronic control system with which predefined scenes of all the loads, in particular lighting devices, can be called up in a simple manner as overall actuation states of the control unit. These scenes can be programmed simply and without additional programming devices such as a display or menu navigation means. A programmed scene, that is to say a specific combination of different loads, in particular lights, at predefined brightnesses (dimming states) can be called up by simple operation of an associated key. An entire scene can therefore be established with a single press of a key.

Overall, different lighting moods (scenes) can be generated, stored and called up again later by simply pressing a key by means of the control system according to the invention. These measures can all also be executed by operators without special technical knowledge; persons skilled in the art, or experts, are not required for this purpose. Programming is performed by means of the existing buttons in a simple manner; no additional devices are required for this purpose. Simple operator control and also programming leads to a considerable increase in comfort, and the ability to use standard buttons permits cost-effective production of the electronic control system according to the invention.

### LIST OF REFERENCE SYMBOLS

1 Electronic control system

2 Operator control unit

3, 3a-c First operating elements

4, 4a-d Second operating elements

5 Control unit

6 Load, lighting device

7, 8 Electrical connections

We claim:

1. An electronic control system, in particular an electronic light control system, for a mobile home, in particular a trailer and/or a motor home and/or a boat, comprising:
a) at least one electrical load;
b) a control unit which actuates the load or loads; and
c) at least one operator control unit with one or more first operating elements;
d) wherein the operator control unit is connected to the control unit in such a way that said control unit can be controlled by means of the operator control unit;
wherein:
e) a predefined overall actuation state of the control unit, which state is or can be stored in the control unit and can be activated by operating the respective first operating element, is in each case associated with the first operator control element or elements; and
f) the control unit is designed in such a way that it actuates all the electrical loads of the electronic control system in a respectively predefined manner in each predefined overall actuation state.

2. The electronic control system as claimed in claim 1, wherein the overall actuation, state which is in each case associated with a first operating element is identified, in particular symbolized, by marking, in particular printing, of the corresponding first operating element.

3. The electronic control system as claimed in claim 1, wherein the load is a lighting device or the loads comprise one or more lighting devices and therefore each overall actuation state is an overall lighting state.

4. The electronic control system as claimed in claim 3, wherein the control unit is designed to:
switch on the lighting devices; and
switch off and/or dim the lighting devices.

5. The electronic control system as claimed in claim 3, wherein the control unit is designed in such a way that it actuates each lighting device in each overall lighting state in such a way that said lighting device:
lights up with a light intensity which is predefined for the overall lighting state; or
is switched off.

6. The electronic control system as claimed in claim 1, wherein the operator control unit has one or more second operating elements by means of which the control unit can be controlled for individual actuation of individual loads.

7. The electronic control system as claimed in claim 6, wherein the first operating elements and second operating elements are arranged in separate element blocks on the operator control unit.

8. The electronic control system as claimed in claim 1, wherein the predefined overall actuation states are or can be set in the control unit by programming and/or are or can be stored in the control unit after the programming.

9. The electronic control system as claimed in claim 1, wherein:
the control unit is designed in such a way that the load or loads can be individually actuated by means of the control unit, in particular by operating the corresponding second operating elements;
and an overall actuation state of the control unit, which is set in this way, can be stored in the control unit and can be associated with one of the first operating elements, in particular by operating this first operating element.

10. The electronic control system as claimed in claim 1, wherein the overall actuation state, which is in each case associated with the first operating element or elements, can be changed.

11. The electronic control system as claimed in claim 1, wherein a predefined overall actuation state is associated with each first operating element as a factory setting.
